(19) United States
(12) Patent Application Publication
(10) Pub. No.: US 2024/0015718 A1
(43) Pub. Date: Jan. 11, 2024

(54) ELECTRONIC DEVICE AND METHOD IN A WIRELESS COMMUNICATION SYSTEM

(71) Applicant: Sony Group Corporation, Tokyo (JP)

(72) Inventors: Jianfei CAO, Beijing (CN); Min LIU, Beijing (CN)

(73) Assignee: Sony Group Corporation, Tokyo (JP)

(21) Appl. No.: 18/245,898

(22) PCT Filed: Oct. 21, 2021
(86) PCT No.: PCT/CN2021/125119

§ 371 Date: Mar. 20, 2023

(30) Foreign Application Priority Data
Oct. 22, 2020 (CN) 202011141627.0

(51) Int. Cl. H04W 72/044; H04B 7/06; H04W 72/23

(52) U.S. Cl. CPC H04W 72/046; H04B 7/06952; H04W 72/23

(57) ABSTRACT

Disclosed are an electronic device and a communication method in a wireless communication system. Provided is a transmit-side electronic device in a wireless communication system, the electronic device including a processing circuit configured to determine a group common beam for communication with a group of terminal devices in the wireless communication system, the group of terminal devices comprising one or more terminal devices; and transmit information about the group common beam to at least one of the terminal devices by using the determined group common beam.

### CROSS-REFERENCE TO RELATED APPLICATION

This application claims the priority of China Patent Application No. 202011141627.0 filed on Oct. 22, 2020, the entire content of which is hereby incorporated by reference.

### FIELD OF THE INVENTION

The present disclosure relates to electronic device and method in a wireless communication system, and in particular, to electronic device and method in a wireless communication system for information communication.

### BACKGROUND

With development and widespread application of mobile Internet technology, wireless communication has unprecedentedly met people's voice and data communication needs. With enhancement of the available frequency bands (such as 26 GHz, 60 GHz or higher frequency bands), wireless channels will definitely suffer greater negative effects such as path loss, atmospheric absorption loss and the like, compared with lower frequency bands (such as 2 GHz). In order to provide higher communication quality and capacity, a wireless communication system uses various technologies at different levels.

In recent years, Massive Multi-Input Multi-Output (MIMO) technology and millimeter wave technology are considered to be parts of key technologies of 5G in the future, and have attracted extensive attention in the academics and industry. The millimeter wave frequency band has a large amount of available spectrum resources, which can meet the growing business traffic demands of mobile communications. In addition, due to the short wavelength of the millimeter wave, according to the antenna theory, the antenna size of a millimeter wave system is also small, so that hundreds or even thousands of antennas can be placed in a small space, which is more conducive to application of a large-scale antenna technology in real systems.

In addition, in the large-scale antenna technology, a beam forming technology can effectively compensate for the shortcomings of excessive millimeter-wave channel path fading, which provides the possibility of applying the millimeter-wave technology to mobile communications. Beamforming can provide beamforming gains to compensate for wireless signal loss by improving directivities of antenna transmission and/or reception. To this end, 3GPP introduced a concept of beam management in the formulation of 5G standards, which set forth determination and application of beams for communication.

Technical solutions for improving beam management for wireless communication transmission are still needed.

Unless otherwise stated, it should not be assumed that any of the methods described in this section become prior art only because they are included in this section. Similarly, unless otherwise stated, the problems recognized about one or more methods should not be assumed to be recognized in any prior art on the basis of this section.

### DISCLOSURE OF THE INVENTION

This disclosure proposes an improved beam communication scheme, and in particular proposes beam management based on grouping of terminal devices, in which a transmit-side electronic device can utilize a group common communication beam for a group of terminal devices to carry out subsequent channel and signal communications, so that unnecessary signaling overhead and delay can be reduced under the premise of reliability being satisified.

An aspect of the present disclosure relates to a transmit-side electronic device in a wireless communication system, the electronic device including a processing circuit configured to determine a group common beam for communication with a group of terminal devices in the wireless communication system, the group of terminal devices comprising one or more terminal devices; and transmit information about the group common beam to at least one of the terminal devices by using the determined group common beam.

Another aspect of the present disclosure relates to a method for a transmit-side in a wireless communication system, the method comprising determining a group common beam for communication with a group of terminal devices in the wireless communication system, the group of terminal devices comprising one or more terminal devices; and transmitting information about the group common beam to at least one of the terminal devices by using the determined group common beam.

An aspect of the present disclosure relates to a receive-side electronic device in a wireless communication system, comprising a processing circuit configured to acquire beam information about a group common beam from a transmit-side electronic device in a wireless communication system; and determine a receive beam for communication with the transmit-side electronic device, based on the acquired beam information.

Another aspect of the present disclosure relates to a method for a receive side in a wireless communication system, the method comprising acquiring beam information about a group common beam from a transmit-side electronic device in a wireless communication system; and determining a receive beam for communication with the transmit-side electronic device, based on the acquired beam information.

Yet another aspect of the present disclosure relates to a non-transitory computer readable storage medium storing executable instructions which, when executed, can cause implementation of the method as mentioned above.

Yet another aspect of the present disclosure relates to a wireless communication device. According to an embodiment, the wireless communication device comprises a processor and a storage device having stored instructions thereon which, when executed, can cause implementation of the method as mentioned above.

Yet another aspect of the present disclosure relates to a wireless communication apparatus comprising means for performing the method as mentioned above.

### DESCRIPTION OF THE DRAWINGS

Hereinafter, the above and other objects and advantages of the present disclosure will be further described in combination with specific embodiments with reference to the accompanying drawings. In the drawings, like terms will be denoted by like reference numerals.

FIG. 1 shows an exemplary application scenario according to an embodiment of the present disclosure.

FIG. 2A shows a conceptual flowchart of group-based beam management according to an embodiment of the present disclosure, FIG. 2B shows an exemplary beam sweeping between a transmit-side device and a terminal-side device according to an embodiment of the present disclosure, and FIG. 2C shows a schematic diagram of the result of group-based beam management according to an embodiment of the present disclosure.

FIG. 3 shows a block diagram of a transmit-side electronic device according to an embodiment of the present disclosure.

FIG. 4 shows a schematic diagram of beam management according to an embodiment of the present disclosure in a case where a terminal device moves.

FIG. 5 shows a schematic diagram of implementing beam management between a base station and a group of terminal devices by using beam sweeping according to an embodiment of the present disclosure.

FIG. 6 shows a schematic diagram of group common beam indication based on a group common PDCCH according to an embodiment of the present disclosure.

FIG. 7 shows a schematic diagram of the format of MAC-CE according to an embodiment of the present disclosure.

FIG. 8 shows a schematic diagram of group common beam indication based on medium access control layer signaling of terminal device-dedicated PDSCH according to an embodiment of the present disclosure.

FIG. 9 shows a schematic diagram of group common beam indication based on medium access control layer signaling of group common PDSCH according to an embodiment of the present disclosure.

FIG. 10 shows a schematic diagram of transmission of information about group common beams between a key terminal device and other terminal devices according to an embodiment of the present disclosure.

FIG. 11 shows a conceptual flow diagram of group-based beam management according to an embodiment of the disclosure.

FIG. 12 shows an example of terminal device grouping without beam management according to an embodiment of the present disclosure.

FIG. 13 shows a flowchart of a method for the transmit-side according to an embodiment of the present disclosure.

FIG. 14 shows a block diagram of a terminal-side electronic device according to an embodiment of the present disclosure.

FIG. 15 shows a flowchart of a method for the terminal side according to an embodiment of the present disclosure.

FIG. 16 illustrates a block diagram showing an exemplary hardware configuration of a computer system capable of implementing an embodiment of the present invention.

FIG. 17 is a block diagram illustrating a first example of a schematic configuration of an eNB to which the technology of the present disclosure can be applied.

FIG. 18 is a block diagram illustrating a second example of a schematic configuration of an eNB to which the technology of the present disclosure can be applied.

FIG. 19 is a block diagram illustrating an example of a schematic configuration of a smartphone to which the technology of the present disclosure can be applied; and

FIG. 20 is a block diagram illustrating an example of a schematic configuration of a vehicle navigation device to which the technology of the present disclosure can be applied.

Although the embodiments described in this disclosure may be susceptible to various modifications and alternative forms, specific embodiments thereof are shown by way of example in the drawings and are described in detail herein. It should be understood, however, that the drawings and detailed description thereof are not intended to limit the embodiments to the particular forms disclosed, but on the contrary, the intention is to cover all modifications, equivalents, and alternatives falling within the spirit and scope of the claims.

### DETAILED DESCRIPTION OF PREFERRED EMBODIMENTS

Hereinafter, exemplary embodiments of the present disclosure will be described with reference to the accompanying drawings. In order to avoid obscuring the present disclosure by unnecessary details, only processing steps and/or equipment structures closely related to the schemes at least according to the present disclosure are shown in the drawings, while other details not closely related to the present disclosure are omitted. It should be noted that similar reference numerals and letters indicate similar items in the drawings, and therefore, once an item is defined in one drawing, there is no need to discuss it for subsequent drawings.

For the sake of clarity and conciseness, not all features of the embodiments are described in the description. However, it should be understood that many implementation-specific settings must be made during the implementation of the embodiments in order to achieve specific goals of developers, for example, to meet those constraints related to equipment and business, and these constraints may vary with different implementations. In addition, it should be understood that although the development work may be very complicated and time-consuming, it is only a routine task for those skilled in the art who benefit from this disclosure.

Typically, a wireless communication system or a radio system includes at least a transmit-side and a receive-side, and a transmit-side device and a receive-side device communicate by transmitting and receiving signal streams therebetween. In this disclosure, “transmit-side” has the full breadth of its usual meaning, and generally indicates a side in the system that transmits signal streams for communication and/or controlling, which also can be referred as “control side” in the system for signals, they can be used exchangeably in the context of the present disclosure. Similarly, “receive-side” has the full breadth of its usual meaning, and generally indicates a side in the system that receives the signal streams for communication and/or controlling, which also can be referred to as “terminal side” in the system for signals, they can be used exchangeably in the context of the present disclosure.

As an example, “transmit-side” and “receive-side” may encompass different devices in a communication system depending on the direction of signal flow in the communication system and/or operational controls in the communication system. For example, for downlink signal transmission, the “transmit-side” device may include a base station, a control device, a server or MEC, a repeater or a roadside unit (RSU), etc. in a wireless communication system such as a cellular communication system, a V2X system, etc., and the “receive-side” device may correspondingly include terminal device in the communication system. Conversely, for uplink signal transmission, the “transmit-side” device may include terminal device in the communication system, and the “receive-side” device may correspondingly include base station in the communication system and so on.

In this disclosure, “base station” has the full breadth of its usual meaning, and as an example, the base station may be, for example, an eNB in a 4G communication standard, a gNB in a 5G communication standard, a remote radio head, a wireless access point, a UAV control tower, or a communication apparatus performing similar functions.

In this disclosure, the term “terminal device” has the full breadth of its general meaning, and includes at least a terminal device which is a part of a wireless communication system or a radio system that receive signals from the transmit-side device to facilitate communication. As an example, the terminal device may be, for example, a terminal equipment such as a wireless relay, a micro base station, a router, user equipment, etc., or a communication device that performs similar functions. In this disclosure, “terminal device” and “user equipment (UE)” can be used interchangeably, or “terminal device” can be integrated with “user equipment”, or be implemented as a part of “ user equipment”. In the present disclosure, the term “user equipment (UE)” has the full breadth of its usual meaning, and as an example, the UE may be a terminal equipment such as a mobile phone, a laptop computer, a tablet computer, a vehicle on-board communication device, or the like, or a communication apparatus that performs similar functions.

In the current 5G wireless communication system, especially in the field of millimeter wave technology, transmit-side devices, such as base stations, often use antennas to produce directional beams for communication with receive-side devices, such as terminal devices. In particular, in the wireless communication system, especially millimeter-wave communication system, each radio frequency link usually connects to multiple phase shifters and antennas so that at least one radio frequency link can be used to form directional beams, and a beamforming scheme can be used to find matching beam pairs between the transmit-side device and the receive-side device for subsequent wireless communication. As an example, taking downlink as an example, downlink beamforming training can be performed by beam sweeping between transmit beams of the base station and receive beams of the user equipment to obtain beam pairs for downlink, that is, to find a set of optimal beam pairs formed by an optimal base station transmit beam and an optimal user equipment receive beam. Similarly, in the uplink, the receive beam of the base station and the transmit beam of the user equipment also form a set of beam pairs.

However, in a 5G communication system, the overhead of beam communication between the transmit-side device and the terminal device is worthy of attention, especially when a transmit-side device, such as a base station, often serves multiple terminal devices, such as mobile user equipments, the signaling overhead of beam management for communication between the base station and multiple user equipments is especially worthy of attention. In the current technology, the beam management between the base station and each user equipment is carried out through separate signaling interaction therebetween, so that the base station always needs to perform multiple repetitive signaling operations, and the signaling overhead in the beam management is high.

In view of this, the present disclosure studies reduction of signaling overhead in beam management by grouping terminal devices in a 5G communication system. In particular, the present disclosure proposes beam management based on grouping of terminal devices, in which one or more terminal devices are grouped into the same group of terminal devices, and for each group of terminal devices, one beam is used for communication between the transmit-side device and each terminal device in the group, such as beam sweeping, group identification information transmission, group common beam information transmission, determination of terminal device receive beams, etc., and providing services for each terminal device in the group. In this way, when the 5G system operates in the millimeter wave frequency band, multiple channels or signals can use the same beam, which can reduce unnecessary signaling overhead and delay while satisfying reliability. In particular, based on the group common beam, the overhead of beam management between the base station and UEs can be reduced through less beam operations and signaling transmissions.

The following will mainly use a base station as an example of transmit-side device/control-side device and a user equipment as an example of receive-side device/terminal-side device, and describe the technical solution according to the present disclosure, in the downlink communication scenario between the base station and the user equipment. It should be pointed out that although the embodiments of the present disclosure are mainly described below based on a communication system including a base station and user equipments, these descriptions can be correspondingly extended to a communication system including any other type of control side and terminal side. Moreover, these described operations are equivalently applicable to uplink communication scenarios.

In particular, when some user equipments are gathered together, the base station can use the same downlink beam to serve such user equipments constituting a user equipment group. For example, when multiple user equipments are gathered in a vehicle or a train carriage, the user equipments in the vehicle or the train carriage can be grouped together, and the base station can use the same downlink beam to serve the group of user equipments in the vehicle or train carriage.

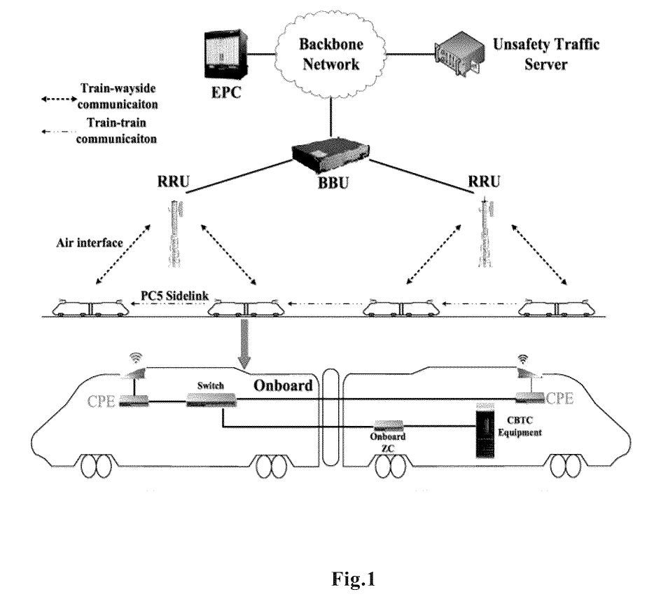

As an example, FIG. 1 shows a communication scenario between a transmit-side/control side device and receive-side/terminal side devices in a train environment. Among them, the transmit-side device may include at least one of BBU (Baseband Processing Unit), RRU (Remote Radio Frequency Unit), etc. shown in the figure, which are used to control and communicate with equipments in the train, and the terminal device may include at least one of CPE (front-end equipment) and the user equipments in the train as shown in the figure. Among them, terminal devices in a train or even a train carriage can communicate with the transmit-side device as a terminal device group. In addition, information can be shared between carriages in a train, between adjacent vehicles in a fleet, and between a vehicle and the header vehicle. For example, information can be shared in the fleet by way of multicast using sidelink. The above communication scenarios are also applicable to various other wireless communication scenarios using sidelink multicast communication, such as robot formation operation in a smart factory, and the like.

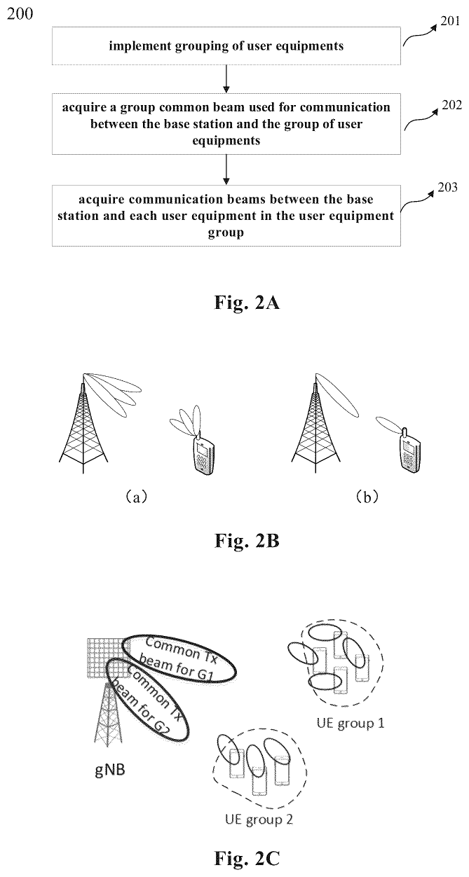

The beam management based on user equipment grouping according to an embodiment of the present disclosure will be schematically described below with reference to the accompanying drawings. FIG. 2A shows a conceptual flow diagram of a group-based beam management process 200 according to an embodiment of the disclosure.

In step 201, grouping of user equipments is implemented. According to an embodiment of the present disclosure, user equipments can be grouped according to position information of the user equipments in a wireless communication system. In particular, as an example, user equipments that are located close to each other may be grouped together, for example, the distance between user equipments that are grouped together tends to be smaller than a certain threshold.

According to an embodiment of the present disclosure, grouping of user equipments may be performed by a base station communicating with the user equipments. In particular, the base station can obtain position information of respective user equipments it serves, and group the user equipments according to the position information. The position information of a user equipment may be reported by the user equipment to the base station, for example, through the GPS system; or the user equipment may send position-related information to the base station so that the base station can estimate the position of the user equipment based on the information, for example, the user equipment transmits uplink SRS taking positioning as the target, so that the base station can estimate the position of the user equipment; or the position information of the user equipment can be known by other devices in the system, and the base station can learn the position information of the user equipment from the other devices, so that grouping of user equipments can be implemented based on the position information.

According to an embodiment of the present disclosure, the grouping of user equipments can be implemented by other devices in the system, and the base station can learn information about grouping of user equipments from the other devices. As an example, other control devices, access points, etc. in the wireless communication system can obtain positions of the user equipments and perform grouping, and then inform the base station of the grouping information. For example, in V2X, a RSU can participate in grouping of vehicles and inform the base station of information about the vehicle grouping.

According to an embodiment of the present disclosure, the information about user equipment grouping can be obtained and notified to the user equipments by the base station, or can be notified to the user equipments by other devices in the system that realize the grouping of user equipments, so that the user equipment can know its own grouping state.

In step 202, a group common beam used for communication between the base station and the group of user equipments is acquired. According to an embodiment of the present disclosure, the group common beam refers to a common beam used by the base station to communicate with each user equipment in the group, so that the base station can use one common beam for multiple user equipments included in the user equipment group, and thus the communication overhead can be effectively reduced.

According to an embodiment of the present disclosure, a group common beam is acquired through beam sweeping between a base station and a specific user equipment in a user equipment group. Beam sweeping can be implemented in various ways. FIG. 2B shows a schematic diagram of a beam sweeping operation according to an embodiment of the present disclosure, in which the base station uses several transmit beams with directivities to communicate with several receive beams of the user equipment with multiple directivities, to form multiple beam pairs, as shown in (a). Then a beam pair with the best communication quality can be selected from these beam pairs as the desired pair of transmit beam and receive beam, as shown in (b), for subsequent communication between the base station and the user equipment. It should be pointed out that the beam sweeping for beam management shown in FIG. 2B is only exemplary, and the beam pairing between the base station and the user equipment can be performed in various appropriate ways. For example, the base station and one of the user equipments may utilize omnidirectional antennas to perform beam pairing; the base station and the user equipment may respectively utilize horizontal beams and vertical beams to perform beam pairing, etc., which will not be described in detail here.

In step 203, communication beams between the base station and each user equipment in the user equipment group are acquired. In particular, although the base station can use the same downlink beam to transmit data channel, control channel and downlink reference signal to the user equipments, the user equipments may have different positions and equipment postures, so that they need to use respective receive beams for reception.

According to an embodiment of the present disclosure, the base station may use the previously acquired group common beam to perform beam sweeping with each user equipment, and then further acquire beam pairs for communication between the base station and each user equipment, especially the receive beam of the user equipment. In such a beam pair determination operation, the base station only needs to use one common beam to perform beam sweeping, which effectively reduces operation overhead. Here, the beam sweeping operation may be performed in the manner of the beam sweeping operation as described above.

FIG. 2C shows a schematic diagram of the results of group-based beam management at the control side and the terminal side according to an embodiment of the present disclosure. Among them, the user equipments in a cell served by the base station are divided into two groups, UE group 1 and UE group 2. Moreover, the base station uses a common downlink transmit (Tx) beam (that is, a group common beam) to transmit data channels, control channels and downlink reference signals to the user equipment group, and the user equipment uses respective receive beams for reception.

Therefore, by grouping user equipments and performing beam management on a group basis, especially using a group common beam, at least the beam operation overhead on the base station side during operation can be reduced, thereby effectively reducing operation overhead and signaling interaction overhead, and improving system communication performance.

Implementations of a transmit-side electronic device and a receive-side electronic device according to an embodiment of the present disclosure will be described below. In this disclosure, “transmit-side electronic device” has the full breadth of its usual meaning, for example, may include an equipment that is part of a wireless communication system or radio system for transmitting signals for communication and control, and may be used with “control-side electronic device” interchangeably. In some embodiments, the transmit-side electronic device may be a transmit-side device or a part of the transmit-side device. In this disclosure, the term “receive-side electronic device” has the full breadth of its usual meaning, and includes at least an equipment that is part of a wireless communication system or radio system to receive signals for communication and operation, and can be used with “terminal side electronic device” interchangeably. In some embodiments, the receive-side electronic device may be a receive-side device, i.e., a terminal device, or a part of the receive-side device.

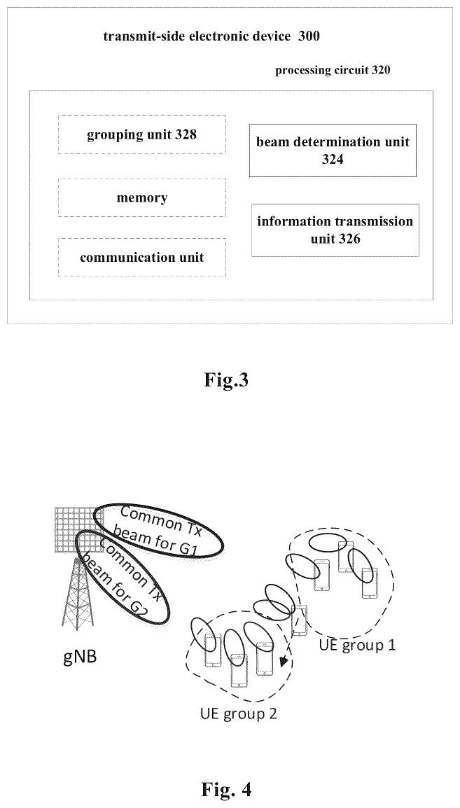

FIG. 3 shows a schematic block diagram of a transmit-side electronic device 300 according to an embodiment of the present disclosure. The transmit-side electronic device 300 can communicate with receive-side electronic devices in the wireless communication system, especially performing beam communication.

As shown in FIG. 3, the transmit-side electronic device 300 may include a processing circuit 320. According to an embodiment of the present disclosure, the processing circuit 320 may be configured to determine a group common beam for communication with a group of terminal devices in the wireless communication system, the group of terminal devices comprising one or more terminal devices; and transmit information about the group common beam to at least one of the terminal devices by using the determined group common beam.

As previously mentioned, the grouping of terminal devices may be performed by appropriate devices in the system based on positions of the terminal devices. According to an embodiment of the present disclosure, the grouping of the terminal devices may be performed by the transmit-side device. In particular, the processing circuit of the transmit-side electronic device may group the terminal devices based on the acquired information about positions of the terminal devices in the wireless communication system. As an example, as mentioned above, the information about positions of the terminal devices can be obtained directly or estimated.

According to an embodiment of the present disclosure, the processing circuit of the transmit-side electronic device can notify the terminal devices of the grouping information through signaling, and for example, can notify each terminal device of the information about grouping of terminal devices in the wireless communication system through radio resource control (RRC) or medium access control (MAC) signaling. In this way, for a terminal device, the terminal device can know which group it belongs to.

The grouping state according to the present disclosure can be indicated by appropriate information. According to an embodiment of the present disclosure, the grouping information may be an identifier indicating a group of terminal devices, in particular, the grouping information may include a Radio Network Temporary Identifier (RNTI) of the group to which the terminal device belongs.

As an example, the transmit-side device may transmit the RNTI through signaling in RRC (Radio Resource Control) layer to inform a terminal device to which group it belongs. This especially applies if the terminal device belongs to one group.

Note that there also exists a case where a terminal device may belong to more than one groups. For example, a terminal device may belong to two groups at the same time, or may successively belong to different groups through mobility. As another example, if the terminal device belongs to more than one groups, the transmit-side device may use lower layer MAC (Media Access Control) signaling or physical layer signaling, such as MAC CE (Media Access Control-Control Element) or DCI (Downlink Control Information), to transmit RNTI to inform the terminal device of the group it belongs to, and/or can also notify the terminal device to adjust the grouping. For example, when the terminal device changes its grouping state due to mobility, the transmit-side device may notify the terminal device of the grouping change through MAC-CE or DCI.

FIG. 4 shows a scenario where a UE may belong to two groups and move. For a UE at the boundary between two groups in FIG. 4, the base station can allocate it into two groups, namely Group 1 and Group 2, with respectively assigned group common (GC) RNTIs, namely GC-RNTI 1 and GC-RNTI 2. The state of GC-RNTI assigned to the UE can be changed based on conditions of the UE and the base station.

Particularly, when the UE moves from Group 1 to Group 2, the base station can change the grouping of the UE through MAC CE, that is, deactivate GC -RNTI 1 and activate GC-RNTI 2. As another example, if the UE has a strong beamforming capability, it can be served by Group 1 and Group 2 at the same time, that is, the assigned GC-RNTI 1 and GC-RNTI 2 are both active. This depends on reporting capability of the UE and corresponding configuration of the base station.

After the UE group is determined, beam management between the base station and the user equipment may be performed based on the group, so as to determine a beam for communication between the base station and the user equipments. In particular, a group common beam for communication with the user equipment group can be determined, so that the base station can use the group common beam as a transmit beam to communicate with each user equipment in the group, and each user equipment can use a corresponding receive beam for receive communication.

According to an embodiment of the present disclosure, the processing circuit of the transmit-side electronic device is further configured to determine the group common beam by performing beam sweeping by a control-side device with respect to a key terminal device in the group of terminal devices . In particular, a key terminal device indicates a specific device that serves as a representative of the terminal device group to communicate with the transmit-side electronic device, the key terminal device may be a terminal device in the terminal device group, or may be a terminal device associated with the terminal device group, for example, CPE of a train in a case that terminal devices in the train constitute a terminal device group, and so on.

According to an embodiment of the present disclosure, the key terminal device may be properly determined in various ways. According to an embodiment, the key terminal device can be selected based on communication capabilities of the terminal-side devices. As an example, a terminal device in the terminal device group with the best power, antenna size, and channel condition may serve as the key terminal device. As another example, a device associated with the terminal device group can serve as the key terminal device due to its better communication capability. For example, in a train application scenario, a CPE installed on the train roof generally is superior to ordinary UEs in the train in terms of power, antenna size, and channel condition, and can serve as the key device responsible for communication between the user equipment group in the train and the base station.

According to an embodiment, the key terminal device may be determined statically or semi-statically. For example, the key terminal device can be determined and remain unchanged during communication between the base station and the terminal devices.

According to another embodiment, the key terminal device may be determined dynamically. In particular, the key terminal device can be determined by polling among multiple terminal devices in the terminal device group. This polling can be performed in various ways. As an example, by comparing the performances of respective terminal devices, such as power, channel condition, etc., among multiple terminal devices, a terminal device with the best performance can be selected as the key terminal device. Certainly, the polling of terminal devices may also be performed with reference to other performance conditions. As an example, the polling may be performed periodically or triggered by an event, such as when a new user equipment joins or an existing user equipment exits. In this way, the key terminal device can be changed dynamically, which can ensure that each terminal device will not pay too much due to group beam management.

After the key terminal device is determined, the group common beam used by the base station to communicate with the user equipment group can be determined by beam sweeping between the determined key terminal device and the base station. In particular, the role of the key terminal device is to serve a representative of the entire terminal device group to find a common downlink transmit beam of the base station for the terminal device group as a group common beam. After the group common beam is determined, the key terminal device can notify the base station of the group common beam through a beam reporting mechanism.

The group common beam can be determined by using a beam sweeping method known in the art, such as the method of determining a beam pair as described above with reference to FIG. 2B, or other methods known in the art.

As an example, in 3GPP, a base station selects a beam suitable for communication with a key terminal device based on a reference signal for downlink beamforming. Such a downlink reference signal is also called a channel state information reference signal (CSI-RS). First, the base station transmits multiple CSI-RSs using multiple beams. Then, the key terminal device uses multiple receive beams for reception, and selects an appropriate beam from the multiple beams used to transmit the CSI-RSs as the group common beam based on the receiving results of the multiple CSI-RSs. For example, the terminal device selects a downlink transmit beam corresponding to the maximum received signal strength as the group common beam, or may select a downlink transmit beam with the best communication quality as the group common beam. Then, the user equipment reports information indicating the selection result to the base station, the information may include, for example, identification information of the desired beam, such as the beam number, so that the base station can use the selected transmit beam as the group common transmit beam for communication with the terminal equipment group.

Finally, it should be noted that when the UE has uplink and downlink beam symmetry, the base station can indicate the downlink transmit beam to the UE through TCI state (Transmission Configuration Information state), and the UE can use the corresponding downlink receive beam during downlink receiving, and use the uplink transmission spatial filter corresponding to the corresponding downlink receive beam during uplink transmission. In this way, UE group-based beam indications in both uplink and downlink directions can be realized.

After the group common beam is determined, the base station can use the group common beam to communicate with the terminal device group. According to an embodiment, the processing circuit of the transmit-side electronic device is further configured to: perform beam sweeping with respect to each terminal device in the group of terminal devices by using the group common beam, so as to determine a beam for each terminal device communicating with the transmit-side electronic device.

The beam sweeping and beam determination can be performed using a beam determination method known in the art, for example, the method of determining the uplink and downlink beam pair based on CSI-RS as described above. In particular, the base station uses the determined group common beam to perform beam sweeping with respect to other terminal devices in the terminal device group, and for the group common beam, each terminal device uses its own available receive beams to receive, and determine a receive beam with the best communication quality as the corresponding receive beam for the terminal device. In particular, in order to reduce consumption of receive beam sweeping resources, the base station may allocate the same beam sweeping resources to other UEs in the group except the key UE. As an example, the receive beam determined by the terminal device may not be reported to the base station.

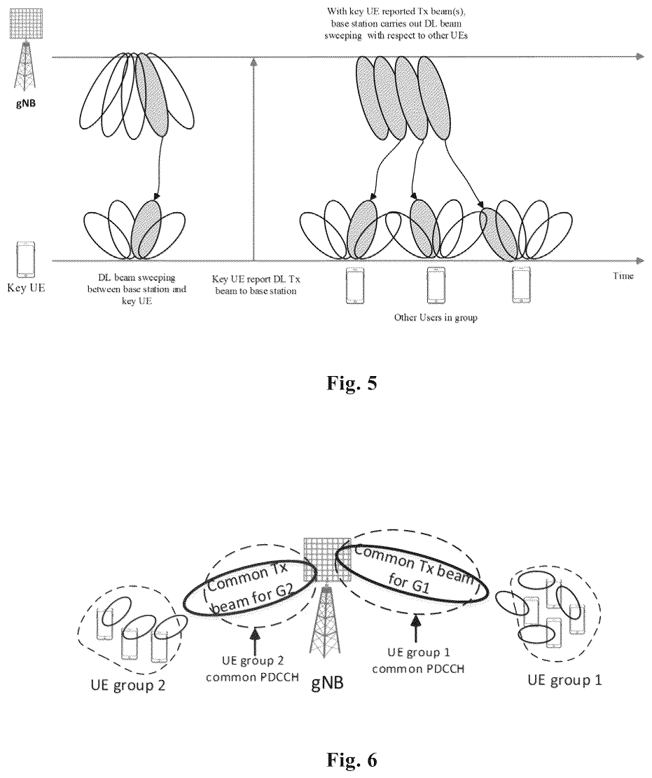

FIG. 5 shows a schematic diagram of results of the group-based beam management between a base station and a terminal device group according to an embodiment of the present disclosure, wherein the downlink transmit beam of the base station is determined through downlink beam sweeping between the base station and a key UE, the key UE reports the determined downlink transmit beam to the base station, and the base station can use the downlink transmit beam as a group common downlink transmit beam for beam sweeping with other UEs in the group, so that the receive beam of each terminal device in the terminal device group can be determined.

According to an embodiment of the present disclosure, a group common beam indication scheme based on grouping of terminal devices is proposed. In this scheme, relevant information about the group common beam may be provided to each terminal device in the terminal device group, especially to other terminal devices except the key terminal device.

According to an embodiment of the present disclosure, this beam indication scheme can be used for receive beam determination for other devices in the terminal device group except the key device, that is, after the key terminal device is used to determine the group common beam of the base station, the beam indication information can be transmitted to the terminal device group, so that the terminal device can receive and decode information about the group common beam contained in the beam indication information, thereby preparing a corresponding receive beam based on the information. As an example, the indication of relevant information about the group common beam may be performed alternately with beam sweeping between the base station and the terminal device. Generally, general beam sweeping can be performed periodically or aperiodically, for example, beam sweeping is triggered by grouping change due to terminal equipment access or mobility, meanwhile beam indication is often aperiodic, for example, the grouping change may cause the group common beam to change, so it is necessary to notify the terminal device of the changed group common beam. For example, the indication of relevant information about the group common beam may be performed after beam sweeping. It should be noted that this beam indication scheme can be performed after determination of beam pair between the base station and each terminal device in the terminal device group as described above.

According to an embodiment of the present disclosure, the relevant information about the group common beam may be provided by various devices to the terminal devices in various appropriate ways. In particular, the relevant information about the group common beam may be provided by the base station or other appropriate devices. As another example, in the beam indication scheme, the relevant information about the group common beam may be transmitted via an appropriate channel. According to an embodiment of the present disclosure, preferably, the relevant information about the group common beam can be provided by the base station to the terminal device, in particular, the relevant information about the group common beam can be provided to each terminal device in the terminal device group by using an appropriate channel through the determined group common beam. Certainly, the relevant information about the group common beam can also be provided to the terminal device through a beam of the base station specific for the terminal device. For example, when the terminal device has just completed the initial access to the base station and no group common beam has been configured for the transmission channel of the terminal device, a beam dedicated to the terminal device can be used to transmit the relevant information about the group common beam to the terminal device.

According to an embodiment of the present disclosure, the relevant information about the group common beam may include direction information of the group common beam, for example, the direction of a group common downlink beam. TCI state is often used for identification in the standard. The TCI state includes a downlink reference signal (CSI-RS or SSB) or an uplink reference signal (SRS).

According to an embodiment, the processing circuit utilizes the group common (GC) beam to transmit the relevant information about the group common beam to the corresponding terminal device group via the group common physical downlink control channel (PDCCH). In particular, the group common physical downlink control channel (PDCCH) may refer to using a common PDCCH for each terminal device in the terminal device group, thereby indicating the relevant information about the group common beam.

FIG. 6 shows a schematic diagram of group common beam indication based on the group common PDCCH according to an embodiment of the present disclosure, where the relevant information about the group common beam is included in the content carried by GC-PDCCH.

There are two groups here, which are UE group 1 and group 2. For the two groups, the corresponding information about group common beam is provided through GC-PDCCH via respective corresponding group common beam, and each UE group is respectively identified by GC-RNTI specific for corresponding group common beam indication. As an example, GC-RNTI may be transmitted together with the relevant information about the group common beam.

If the UEs in group 1 are provided with GC-RNTI 1, they can decode the content in GC-PDCCH 1, because CRC of GC-PDCCH 1 is scrambled by GC-RNTI 1, the decoding process needs to use GC-RNTI 1 to perform a reverse descrambling operation, so that the group common downlink beam direction can be obtained, which is always identified by a TCI state. The TCI state includes a downlink reference signal (CSI-RS or SSB) or an uplink reference signal (SRS). After decoding the GC-PDCCH of the group it belongs to, the UE can obtain the group common beam of the group, and prepare the corresponding receive beam to receive subsequent channels and signals. In addition, in the uplink direction, the UE may prepare the corresponding uplink channel and signal transmission direction.

According to the present disclosure, GC -PDCCH may be in various suitable formats. According to an example, the relevant information about the group common beam, such as the TCI state, etc., can be added to the existing PDCCH signaling format to transmit. According to another embodiment, a new GC-PDCCH format may be introduced. In particular, the embodiment of the present disclosure proposes DCI format 2, which can be used to notify the common downlink of a common TCI state (beam), where the UE assumes that no transmission is expected for the UE. In this way, when the CRC is scrambled by GC-RNTI, the DCI format 2 can be used to transmit the following information: {UE group 1, UE group 2, . . . , UE group N, TCI state 1, TCI state 2, . . . , TCI State N}, where N represents a total of N UE groups. That is, the relevant information about the group common beam for each UE group can be composed into one common information, and the common information can be provided to each group via the group common beam and GC-PDCCH, so that each group can obtain corresponding information about the group common beam based on the common information.

According to another embodiment, the processing circuit may also use the group common beam to transmit the information about the group common beam to each terminal device in the terminal device group via a physical downlink control channel (PDCCH) dedicated to the terminal device. In particular, the group common beam can be used to transmit the information about the group common beam via the PDCCH dedicated to each terminal device, so that after receiving the information, the terminal device can directly decode the content in the corresponding PDCCH to obtain the information about the group common beam, so that it can prepare the corresponding receive beam for subsequent channel and signal reception. But in this case, the channel overhead may be relatively large.

According to an embodiment of the present disclosure, the processing circuit of the transmit-side electronic device may use the group common beam to transmit the relevant information about the group common beam to a corresponding terminal device via a group common Medium Access Control-Control Element (MAC-CE).

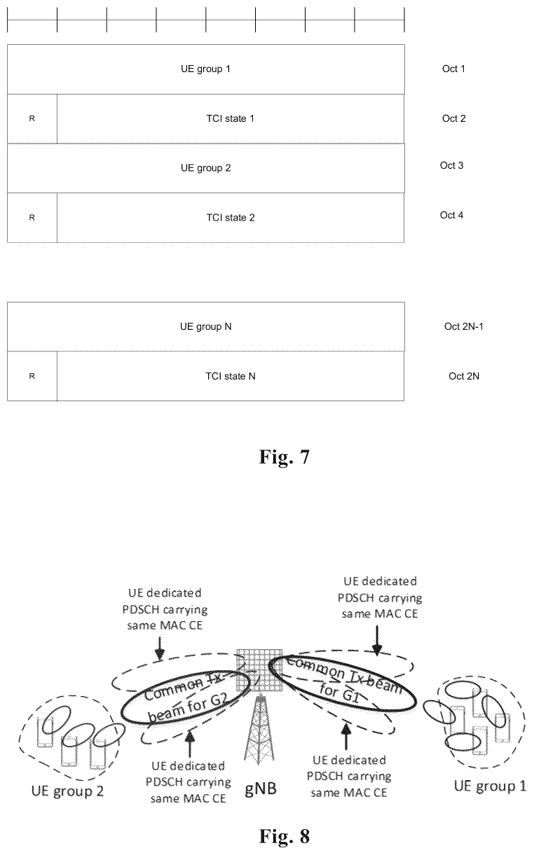

In particular, in addition to the GC-PDCCH-based group common beam indication as considered above, activation or deactivation of uplink and downlink beams can be performed also in consideration of the group common MAC-CE. It is worth mentioning that in the current NR protocol, MAC-CE is generally a UE-specific signaling manner. Here it is proposed to use the concept of GC-MAC CE for beam management. The base station assigns a group-specific group identifier, such as LCID (Local Configuration Identifier) or eLCID, to the MAC CE for identification, and explicitly indicates the terminal device group corresponding to the MAC-CE. FIG. 7 shows the format of MAC-CE according to an embodiment of the present disclosure.

According to an embodiment of the present disclosure, there may exist two transmission modes for GC-MAC CE. FIG. 8 shows a schematic diagram of GC-MAC CE transmission according to an embodiment of the present disclosure, in which, the relevant information about the group common beam is indicated to each terminal device by using the group common beam via the terminal device-dedicated Physical Downlink Shared Channel (PDSCH), the relevant information about the group common beam is included in GC-MAC CE.

As shown in FIG. 8, the GC-MAC CE is carried on the UE-dedicated PDSCH in the physical layer, and the same MAC CE content is placed in the PDSCH dedicated to each UE, in this way, due to the error control mechanism of the HARQ-ACK of the PDSCH, it can ensure that each UE can correctly decode the MAC CE, so as to accurately obtain the relevant information about the group common beam, such as the direction information of the group common beam, so that the corresponding receive beam can be prepared for subsequent channel and signal reception. It should be pointed out that this scheme can achieve accurate transmission and decoding, but the consumption of physical layer radio resources is relatively large.

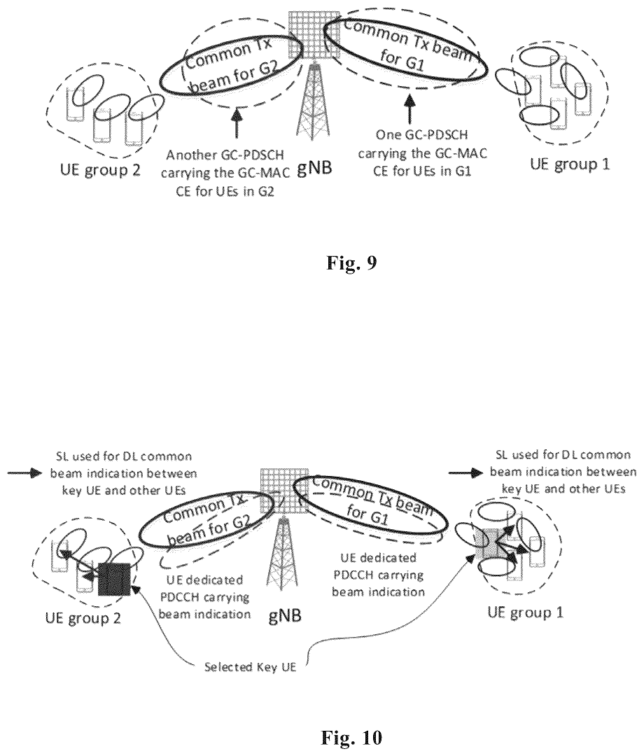

FIG. 9 shows a schematic diagram of GC-MAC CE transmission according to another embodiment of the present disclosure, wherein the processing circuit utilizes the group common beam to transmit the relevant information about the group common beam to each terminal device in the terminal device group via a group common Physical Downlink Shared Channel (PDSCH).

As shown in FIG. 9, the base station can carry GC-MAC CE into GC-PDSCH. After decoding the GC-PDSCH, the terminal device can obtain the group common beam indication carried by the GC-MAC CE. In particular, similar to GC-PDCCH, according to the group identification information, such as RNTI, sent to it, the terminal device can decode the content in the corresponding part of a common PDSCH or a corresponding GC-PDSCH, so as to obtain the content carried in GC-MAC CE. The advantage of this scheme is that the GC-PDSCH only occupies one PDSCH resource at the physical layer, thereby reducing the overhead of radio resources. In addition, for transmission security, a HARQ mechanism can be introduced to protect error transmission.

After decodings the GC-MAC CE of the group it belongs to, the UE can obtain the group common beam for the group, and prepare a corresponding receive beam for subsequent channel and signal reception. In addition, in the uplink direction, the UE may prepare corresponding uplink channel and signal transmission direction.

According to an embodiment of the present disclosure, the relevant information about the group common beam may also be provided by other devices to the terminal devices in the terminal device group. In particular, according to an embodiment of the present disclosure, the key device may notify other terminal devices in the terminal device group to which the key device belongs of the relevant information about the group common beam. In particular, when beam sweeping is performed between the base station and the key device to determine the uplink and downlink beam pairs, the key device has already learned the relevant information about the group common beam to be used by the base station, and notifies the terminal devices in the terminal device group of the information.

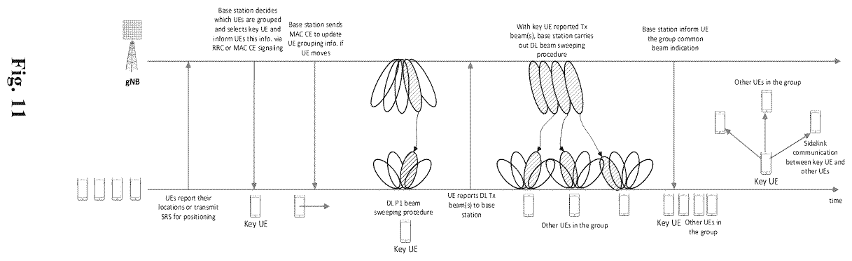

FIG. 10 shows a schematic diagram of group common beam information transmission between a key terminal device and other terminal devices according to an embodiment of the present disclosure. Among them, the base station notifies the key UE of relevant information about uplink and downlink group common beams through a UE-dedicated control channel or data channel. Then the key UE notifies other UEs in the group of the relevant information about the group common beam. The key UE may perform information notification in various appropriate manners. For example, it may be Downlink or Sidelink. It depends on the role and/or functionality of the key UE. If the UE is a non-IAB node UE, it can notify other UEs in the group of beam indication information based on MAC CE or DCI through Sidelink, that is, SCI or PSSCH. If the UE acts as an IAB node, it can link with other UEs through DL.

According to an embodiment of the present disclosure, the key UE may obtain relevant information of other UEs in the group, such as IDs, position information, and the like of other UEs, in various appropriate ways. As an example, for a sidelink UE, the network side can provide preset configuration so that the UE can calculate an identifier (ZoneID) of a region, i.e., a pre-planned position region, in which the UE is located, based on its own position. The key UE only needs to broadcast Sidelink control information, i.e., SCI (Sidelink Control Information), to the region so as to convey the downlink common beam information. As another example, if the base station additionally provides information about other UEs in the group to the key UE in the previous UE grouping stage, the key UE can more accurately find other UEs by broadcasting SCI.

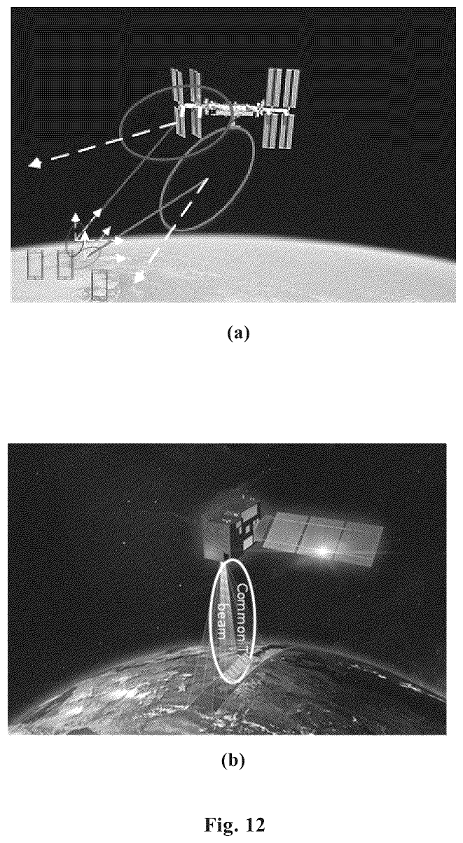

FIG. 11 shows a conceptual flow diagram of beam management based on grouping according to an embodiment of the disclosure. In particular, it should be pointed out that the grouping, determination of group common beams, determination of receive beam of each terminal device, etc. can be performed between the base station and the user equipment in the manner as shown above, which will not be described in detail here.

The beam management based on grouping of terminal devices according to an embodiment of the present disclosure has been described above. Among them, the terminal devices are grouped, and a group common beam of the base station for the terminal device group is determined, so that the communication between the transmit-side device and each terminal device can be performed using the common group common beam, and by means of multiple channels or signals using the same beam, unnecessary signaling overhead and delay can be reduced on the premise that reliability requirement can be satisfied, which is especially beneficial when the 5G system operates in the millimeter wave frequency band.

The above mainly describes the beam management based on grouping, in which UEs are grouped based on their positions, and the group common beam used by the base station and respective receive beams of the UEs are determined based on beam sweeping.

It should be pointed out that in the embodiments of the present disclosure, the grouping of UEs can be performed without beam sweeping and beam management, and the group common beam and respective receive beams of UEs are determined through calculation, without using beam sweeping. In particular, this embodiment is especially suitable for a situation where the distance between the UE and the beam transmitting position is too far. FIG. 12 shows an example of terminal device grouping without beam management according to an embodiment of the present disclosure, which is described by taking a satellite communication scenario as an example. Among them, the user equipments can be grouped without beam management, and the beam management between the base station and the user equipment is no longer performed.

It should be pointed out that for a satellite-based coverage scenario, since each UE can calculate the information about position with respect to the satellite, the process of beam sweeping can be omitted in NTN scenario. Therefore, there is no need for a key UE to distribute the common beam information in the group later. As shown in FIG. 12(a), the network side can notify the UEs it serves of a center angle of the beam used by the satellite, that is, the center direction of a certain beam, through RRC or MAC CE signaling. The UE calculates the angle between the UE and the satellite by calculation of the ephemeris map and its own position. Through the comparison, it can be found the relative position between the UE and the satellite, as well as which beam is more suitable for the UE as the downlink transmit beam. Therefore, in the NTN scenario, the conventional beam sweeping and reporting process are unnecessary.

In addition, it should be noted that due to the long distance between the satellite and UE, a downlink beam can cover a very large range on the earth surface, for example, a region with a radius of 60 km. Therefore, UEs within the region covered by one beam naturally form a UE group, as shown in FIG. 12(b).

In the structural example of the above device, the processing circuit 320 may be in the form of a general-purpose processor, or may be a dedicated processing circuit, such as an ASIC. For example, the processing circuit 320 can be configured by a circuit (hardware) or a central processing device such as a central processing unit (CPU). In addition, the processing circuit 320 may carry a program (software) for operating the circuit (hardware) or the central processing device. The program can be stored in a memory (such as arranged in the memory) or an external storage medium connected from the outside, and downloaded via a network (such as the Internet).

According to one embodiment, the processing circuit 320 may include various units for realizing the above functions, for example, beam determination unit 324 configured to determine a group common beam for communication with a group of terminal devices in the wireless communication system, the group of terminal devices comprising one or more terminal devices; and information transmission unit 326 configured to transmit information about the group common beam to at least one of the terminal devices by using the determined group common beam.

In addition, the processing circuit 320 can further include a unit configured to perform beam sweeping with respect to each terminal device in the group of terminal devices by using the group common beam, so as to determine a beam for each terminal device communicating with the transmit-side electronic device. The unit can be included in the beam determination unit 324, or can be separate from the beam determination unit 324.

In addition, the processing circuit 320 can further include a unit configured to notify each terminal device in the wireless communication system of a group information of the terminal device through radio resource control (RRC) or medium access control (MAC) signaling. The unit can be included in the information transmission unit 326, or can be separate from the information transmission unit 326.

In addition, the processing circuit 320 can further include a unit configured to transmit relevant information about the group common beam to a corresponding group of terminal devices. In particular, a unit configured to utilize the group common beam to transmit relevant information about the group common beam to a corresponding group of terminal devices via a group common physical downlink control channel (PDCCH); a unit configured to utilize the group common beam to transmit relevant information about the group common beam to a corresponding terminal device via a group common medium access control-control element (MAC CE). The units can be included in the information transmission unit 326, or can be separate from the information transmission unit 326.

In addition, the processing circuit 320 can further include a grouping unit 328 configured to group terminal devices in the wireless communication system based on acquired information about positions of the terminal devices.

The above units can operate as described above, and will not be described in detail here. It should be noted that each of the above units only belongs to a logical module classified according to the specific function it implements, instead of limiting its specific implementation manner, for example, it can be implemented in software, hardware, or a combination of software and hardware. In an actual implementation, the foregoing units may be implemented as separate physical entities, or may be implemented by a single entity (for example, a processor (CPU or DSP, etc.), an integrated circuit, etc.). Note that although each unit is shown as a separate unit in FIG. 3, one or more of these units may be combined into one unit or split into multiple units. Furthermore, that the foregoing units are indicated by dotted lines in the figure indicates that the foregoing units may not actually exist, and the operation/functionality they achieve can be implemented by the processing circuit itself.

It should be understood that FIG. 3 is only a schematic structural configuration of the purchase side electronic device, and alternatively, the purchase side electronic device 300 may also include other components not shown, such as a memory, a radio frequency link, a baseband processing unit, a network interface, a controller, and the like. The processing circuit may be associated with a memory and/or an antenna. For example, the processing circuit can be directly or indirectly connected to the memory (for example, other components may be interposed therebetween) to access data. The memory can store various kinds of information (e.g., vehicle internal state information and its analysis result, etc.) acquired and generated by the processing circuit 320, programs and data for the operation of the terminal-side electronic device, data to be transmitted by the terminal-side electronic device, etc. The memory can also be located in the terminal-side electronic device but outside the processing circuit, or even outside the terminal-side electronic device. The memory can be volatile memory and/or nonvolatile memory. For example, the memory may include, but is not limited to, random access memory (RAM), dynamic random access memory (DRAM), static random access memory (SRAM), read only memory (ROM) and flash memory.

For example, the processing circuit can be directly or indirectly connected to the antenna to send information and receive requests/instructions via the transmission unit. For example, as an example, the antenna may be an omni-directional antenna and/or a directional antenna, which may be implemented in various ways, such as an antenna array (such as both omni-directional antenna and directional antenna, or a single antenna array capable of realizing the functions of both omni-directional antenna and directional antenna) and/or a radio frequency link, which will not be described in detail here. As an example, the antenna may also be included in the processing circuit or external to the processing circuit. It can even be coupled/attached to the electronic device 300 without being included in the electronic device 300.

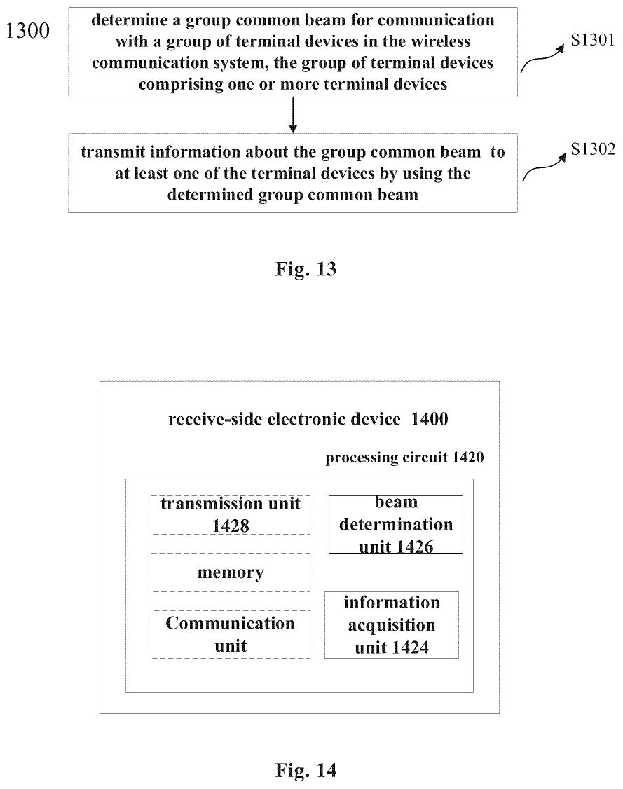

A method for a transmit-side in a wireless communication system according to an embodiment of the present disclosure will be described below with reference to the accompanying drawings, and FIG. 13 shows a flowchart of a method for a transmit-side in a wireless communication system according to an embodiment of the present disclosure.

In step S1301, a group common beam for communication with a group of terminal devices in the wireless communication system is determined, the group of terminal devices comprising one or more terminal devices.

In step S1302, information about the group common beam is transmitted to at least one of the terminal devices by using the determined group common beam.

In addition, the method may further include corresponding steps for implementing the above-mentioned operations performed by the transmit-side electronic device, which will not be described repeatedly here.

It should be noted that these steps can be performed by the above-mentioned transmit-side electronic device according to the present disclosure, particularly by the corresponding units of the above-mentioned transmit-side electronic device according to the present disclosure, or can be performed by a suitable transmit-side device.

A receive-side electronic device of a wireless communication device according to an embodiment of the present disclosure will be described below with reference to drawings, and FIG. 14 is a block diagram of a receive-side electronic device of a wireless communication device according to an embodiment of the present disclosure. The receive-side electronic device 1400 may belong to one or more groups of receive-side electronic devices, and the electronic device 1400 includes a processing circuit 1420 configured to acquire beam information about a group common beam from a transmit-side electronic device in a wireless communication system; and determine a receive beam for communication with the transmit-side electronic device, based on the acquired beam information.

Similar to that for the electronic device at the transmit side as discussed above, the processing circuit of the electronic device at the receive side, and thereby the electronic device at the receive side, can also be implemented in various appropriate forms, which will be no described here in detail. In addition, similar to the contents for the electronic device at the transmit side as described above, the structure/composition of the above-mentioned electronic device at the receive side is only exemplary.

As an example, the processing circuit 1420 may include information acquisition unit 1424 configured to acquire beam information about a group common beam from a transmit-side electronic device in a wireless communication system; and beam determination unit 1426 configured to determine a receive beam for communication with the transmit-side electronic device, based on the acquired beam information.

In addition, the processing circuit 1420 can further include a unit configured to determine the group common beam by performing an initial beam sweeping with a control-side device. The unit may be included in the beam determination unit 1426 or separated from the beam determination unit 1426.

In addition, the processing circuit 1420 can further include transmission unit 1428 configured to report information about the group common beam to the transmit-side electronic device.

In addition, the processing circuit 1420 can further include a unit configured to notify other terminal devices in the group of terminal devices of relevant information about the group common beam. The unit may be included in the transmission unit 1428 or separated from the transmission unit 1428.

It should be noted that the above-mentioned units each only belongs to a logical module classified according to the specific function it implements, instead of limiting its specific implementation manner, which is similar to the description for the transmit side and will not be described in detail here. In addition, similar to the description for the transmit side, the electronic device on the receive side may also include additional or supplementary units/devices, such as memory, communication interface, etc., which will not be described in detail here.

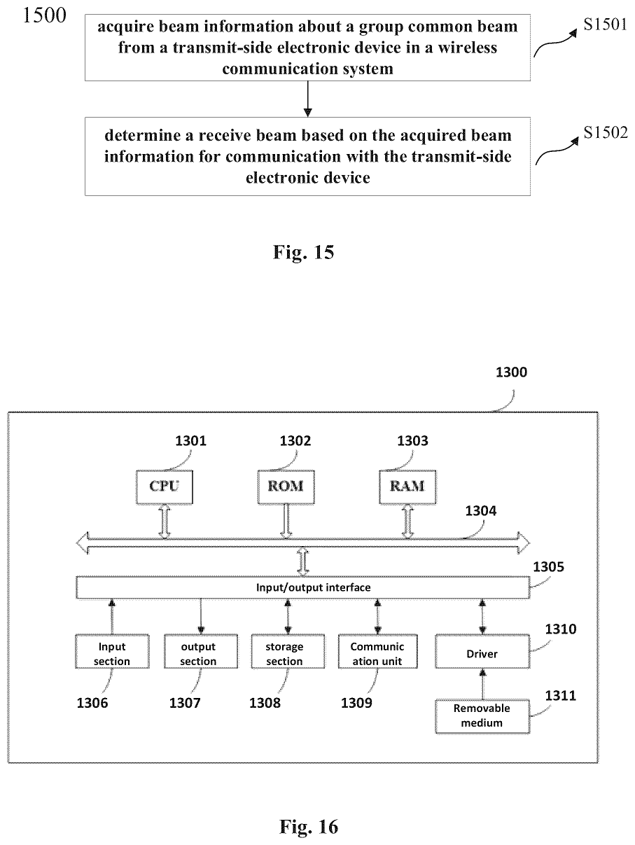

A method for a receive-side in a wireless communication system according to an embodiment of the present disclosure will be described below with reference to the accompanying drawings, and FIG. 15 shows a flowchart of a method for a receive-side in a wireless communication system according to an embodiment of the present disclosure.

In step S1501, beam information about a group common beam from a transmit-side electronic device in a wireless communication system can be acquired.

In step S1502, a receive beam is determined based on the acquired beam information for communication with the transmit-side electronic device.

In addition, the method may further include corresponding steps for implementing the above-mentioned operations performed by the receive-side electronic device, which will not be described repeatedly here.

It should be noted that these steps can be performed by the above-mentioned receive-side electronic device according to the present disclosure, especially by corresponding units of the above-mentioned receive-side electronic device according to the present disclosure, or can be performed by an appropriate receive-side device.

### Application Examples

In this disclosure, an example of a communication scenario of downlink between the base station and the user equipments is described, but it should be understood that the application scenarios of this disclosure are not so limited. The improved scheme proposed in this disclosure can be applied to any cooperative communication application scenario, such as UAV formation flight, intelligent factory robot cooperative operation, etc.

It should be noted that the above description is only exemplary. The disclosed embodiments can also be executed in any other appropriate way, and still achieve the advantageous effects obtained by the disclosed embodiments. Furthermore, the embodiments of the present disclosure can also be applied to other similar application examples, and the advantageous effects obtained by the embodiments of the present disclosure can still be achieved.

It should be understood that the machine-executable instructions in the machine-readable storage medium or program product according to the embodiments of the present disclosure may be configured to perform operations corresponding to the above-mentioned device and method embodiments. When referring to the above device and method embodiments, the embodiments of the machine-readable storage medium or program product are clear to those skilled in the art, and therefore will not be described repeatedly. Machine-readable storage medium and program products for vehiclerying or including the above-mentioned machine-executable instructions also fall within the scope of the present disclosure. Such a storage medium may include, but is not limited to, a floppy disk, an optical disk, a magneto-optical disk, a memory vehicled, a memory stick, and the like.

In addition, it should be understood that the processes and devices described above may also be implemented by software and/or firmware. When implemented by software and/or firmware, a program constituting the software is installed from a storage medium or a network to a computer having a dedicated hardware structure, such as a general-purpose personal computer 1300 shown in FIG. 16, and the computer can perform a variety of functions by installing various programs thereon. FIG. 16 is a block diagram illustrating an example structure of a personal computer as an information processing apparatus that can be adopted in an embodiment of the present disclosure. In one example, the personal computer may correspond to the above -described exemplary transmit device or terminal-side electronic device according to the present disclosure.

In FIG. 16, a central processing unit (CPU) 1301 performs various processes according to a program stored in a read only memory (ROM) 1302 or a program loaded from a storage section 1308 to a random-access memory (RAM) 1303. In the RAM 1303, data required when the CPU 1301 executes various processes and the like is also stored as necessary.

The CPU 1301, the ROM 1302, and the RAM 1303 are connected to each other via a bus 1304. An input/output interface 1305 is also connected to the bus 1304.

The following components are connected to the input/output interface 1305: an input section 1306 including a keyboard, a mouse, etc.; an output section 1307 including a display, such as a cathode ray tube (CRT), a liquid crystal display (LCD), etc., and a speaker, etc.; a storage section 1308 including hard disks, etc.; and communication section 1309 including network interface vehicleds such as LAN vehicleds, modems, etc. The communication section 1309 performs communication processing via a network such as the Internet.

A driver 1310 is also connected to the input/output interface 1305 as needed. A removable medium 1311 such as a magnetic disk, an optical disk, a magneto-optical disk, a semiconductor memory, etc. is installed on the drive 1310 as needed, so that a computer program read out therefrom can be installed into the storage section 1308 as needed.

In a case where the above-mentioned processes are realized by a software, the programs constituting the software are installed from a network such as the Internet or a storage medium such as a removable medium 1311.

Those skilled in the art should understand that such a storage medium is not limited to the removable medium 1311 shown in FIG. 16 in which the program is stored and which is distributed separately from the device to provide the program to the user. Examples of the removable medium 1311 include a magnetic disk (including a floppy disk (registered trademark)), an optical disk (including a CD-ROM and a digital versatile disk (DVD)), and a magneto-optical disk (including a mini disk (MD) (registered trademark))) and semiconductor memory. Alternatively, the storage medium may be the ROM 1302, a hard disk included in the storage section 1308, and the like, in which programs are stored and which are distributed to users along with the device containing them.

The technology of the present disclosure can be applied to various products.

For example, the transmit-side electronic device and/or receive-side electronic device according to embodiments of the present disclosure can be implemented as a variety of control devices/base stations, or be included therein. For example, the transmit-side electronic device and/or receive-side electronic device according to embodiments of the present disclosure can be implemented as a variety of terminal devices or be included therein.

For example, the transmit-side electronic device/base stations mentioned in this disclosure can be implemented as any type of base station, for example, evolved Node B (eNB), such as macro eNB and small eNB. A small eNB may be an eNB covering a cell smaller than a macro cell, such as a pico eNB, a micro eNB, and a home (femto) eNB. Furthermore, for example, the transmit-side electronic device/base stations can be implemented as gNB, such as macro gNB and small gNB. A small gNB may be a gNB covering a cell smaller than a macro cell, such as a pico gNB, a micro gNB, and a home (femto) gNB. Alternatively, the base station can be implemented as any other type of base station, such as a NodeB and a Base Transceiver Station (BTS). The base station may include: a main body (also referred to as a base station device) configured to control wireless communication; and one or more remote radio heads (RRHs) disposed at a place different from the main body. In addition, various types of terminals described below can work as base stations by temporarily or semi-persistently performing base station functions.

For example, in some embodiments, the terminal device mentioned in this disclosure can be implemented as a mobile terminal such as a smart phone, a tablet personal computer (PC), a notebook PC, a portable gaming terminal, a portable/dongle Mobile routers and digital cameras, or vehicle terminals such as vehicle navigation equipment. The terminal device can also be implemented as a terminal that performs machine-to-machine (M2M) communication, also called as a machine type communication (MTC) terminal. In addition, the terminal device may be a wireless communication module mounted on each of the terminals described above, such as an integrated circuit module including a single chip.

Examples according to the present disclosure will be described below with reference to the figures.

### Example of Base Station

It should be understood that the term “base station” in this disclosure has the full breadth of its usual meaning and includes at least a wireless communication station that is used as part of a wireless communication system or radio system for facilitating communication. Examples of base stations may be, for example but not limited to, the following: maybe one or both of a base transceiver station (BTS) and a base station controller (BSC) in a GSM system, may be one or both of a radio network controller (RNC) and Node B in a WCDMA system, may be eNBs in LTE and LTE-Advanced systems, or may be corresponding network nodes in future communication systems (such as gNB, eLTE eNB, etc that may appear in 5G communication systems). Part of the functions in the base station of the present disclosure can also be implemented as an entity with control function for communication in D2D, M2M, and V2V communication scenarios, or as an entity that plays a spectrum coordination role in cognitive radio communication scenarios.

### First Example

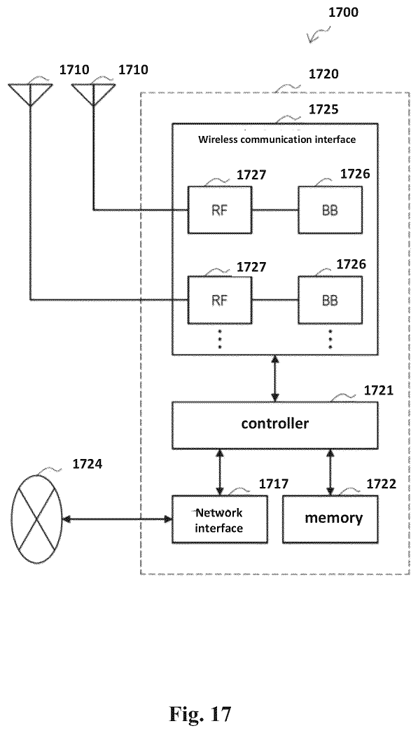

FIG. 17 is a block diagram illustrating a first example of a schematic configuration of a gNB to which the technology of the present disclosure can be applied. The gNB 1700 includes a plurality of antennas 1710 and a base station device 1720. The base station device 1720 and each antenna 1710 may be connected to each other via an RF cable. In an implementation manner, the gNB 1700 (or the base station device 1720) herein may correspond to the above-mentioned transmit-side and/or receive-side electronic device.

Each of the antennas 1710 includes a single or multiple antenna elements, such as multiple antenna elements included in a multiple-input multiple-output (MIMO) antenna, and is used for the base station device 1720 to transmit and receive wireless signals. As shown in FIG. 17, the gNB 1700 may include a plurality of antennas 1710. For example, multiple antennas 1710 may be compatible with multiple frequency bands used by gNB 1700.

The base station device 1720 includes a controller 1721, a memory 1722, a network interface 1717, and a wireless communication interface 1725.

The controller 1721 may be, for example, a CPU or a DSP, and operates various functions of the base station device 1720 at a higher layer. For example, the controller 1721 determines position information about a target terminal device in at least one terminal device on the terminal side of a wireless communication system based on the position information and specific position configuration information about the at least one terminal device acquired via a wireless communication interface 1725. The controller 1721 may have logical functions that perform controls such as radio resource control, radio bearer control, mobility management, admission control, and scheduling. The controls can be performed in conjunction with a nearby gNB or core network node. The memory 1722 includes a RAM and a ROM, and stores a program executed by the controller 1721 and various types of control data such as a terminal list, transmission power data, and scheduling data.

The network interface 1717 is a communication interface for connecting the base station device 1720 to the core network 1724. The controller 1721 may communicate with a core network node or another gNB via the network interface 1717. In this case, the gNB 1700 and the core network node or other gNBs may be connected to each other through a logical interface such as an S1 interface and an X2 interface. The network interface 1717 may also be a wired communication interface or a wireless communication interface for a wireless backhaul line. If the network interface 1717 is a wireless communication interface, compared with the frequency band used by the wireless communication interface 1725, the network interface 1717 can use a higher frequency band for wireless communication.

The wireless communication interface 1725 supports any cellular communication scheme such as Long Term Evolution (LTE) and LTE-Advanced, and provides a wireless connection to a terminal located in a cell of the gNB 1700 via an antenna 1710. The wireless communication interface 1725 may generally include, for example, a baseband (BB) processor 1726 and an RF circuit 1727. The BB processor 1726 may perform, for example, encoding/decoding, modulation/demodulation, and multiplexing/demultiplexing, and execute various types of signal processing in layers such as L1, Medium Access Control (MAC), Radio Link Control (RLC), and Group Data Convergence Protocol (PDCP). As an alternative of the controller 1721, the BB processor 1726 may have a part or all of the above-mentioned logical functions. The BB processor 1726 may be a memory storing a communication control program, or a module including a processor and related circuits configured to execute the program. Updating the program can change the function of the BB processor 1726. The module may be a vehicled or a blade inserted into a slot of the base station device 1720. Alternatively, the module may be a chip mounted on a vehicled or a blade. Meanwhile, the RF circuit 1727 may include, for example, a mixer, a filter, and an amplifier, and transmits and receives a wireless signal via the antenna 1710. Although FIG. 17 illustrates an example in which one RF circuit 1727 is connected to one antenna 1710, the present disclosure is not limited to this illustration, but one RF circuit 1727 may be connected to multiple antennas 1710 at the same time.

As shown in FIG. 17, the wireless communication interface 1725 may include a plurality of BB processors 1726. For example, the plurality of BB processors 1726 may be compatible with multiple frequency bands used by gNB 1700. As shown in FIG. 17, the wireless communication interface 1725 may include a plurality of RF circuits 1727. For example, the plurality of RF circuits 1727 may be compatible with multiple antenna elements. Although FIG. 17 illustrates an example in which the wireless communication interface 1725 includes a plurality of BB processors 1726 and a plurality of RF circuits 1727, the wireless communication interface 1725 may also include a single BB processor 1726 or a single RF circuit 1727.

### Second Example

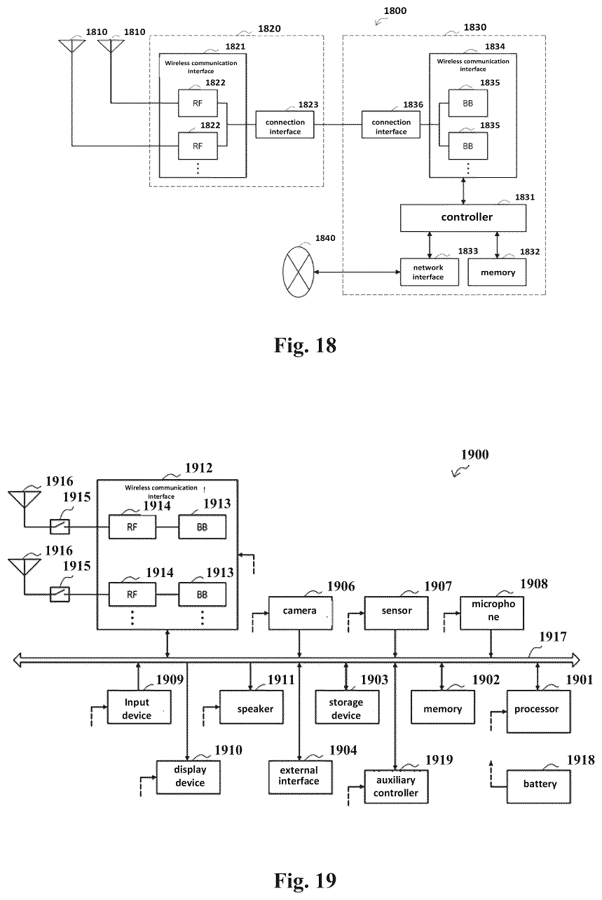

FIG. 18 is a block diagram illustrating a second example of a schematic configuration of a gNB to which the technology of the present disclosure can be applied. The gNB 1800 includes multiple antennas 1810, RRH 1820 and base station equipment 1830. The RRH 1820 and each antenna 1810 may be connected to each other via an RF cable. The base station equipment 1830 and the RRH 1820 may be connected to each other via a high-speed line such as a fiber optic cable. In an implementation manner, the gNB 1800 (or the base station equipment 1830) herein may correspond to the foregoing transmit-side and/or receive-side electronic device.

Each of the antennas 1810 includes a single or multiple antenna elements (such as multiple antenna elements included in a MIMO antenna) and is used for RRH 1820 to transmit and receive wireless signals. As shown in FIG. 18, the gNB 1800 may include multiple antennas 1810. For example, multiple antennas 1810 may be compatible with multiple frequency bands used by gNB 1800.

The base station device 1830 includes a controller 1831, a memory 1832, a network interface 1833, a wireless communication interface 1834, and a connection interface 1836. The controller 1831, the memory 1832, and the network interface 1833 are the same as the controller 1721, the memory 1722, and the network interface 1717 described with reference to FIG. 17.

The wireless communication interface 1834 supports any cellular communication scheme such as LTE and LTE-Advanced, and provides wireless communication to a terminal located in a sector corresponding to the RRH 1820 via the RRH 1820 and the antenna 1810. The wireless communication interface 1834 may typically include, for example, a BB processor 1835. The BB processor 1835 is the same as the BB processor 1726 described with reference to FIG. 17 except that the BB processor 1835 is connected to the RF circuit 1822 of the RRH 1820 via the connection interface 1836. As shown in FIG. 18, the wireless communication interface 1834 may include a plurality of BB processors 1835. For example, multiple BB processors 1835 may be compatible with multiple frequency bands used by gNB 1800. Although FIG. 18 illustrates an example in which the wireless communication interface 1834 includes a plurality of BB processors 1835, the wireless communication interface 1834 may also include a single BB processor 1835.

The connection interface 1836 is an interface for connecting the base station device 1830 (wireless communication interface 1834) to the RRH 1820. The connection interface 1836 may also be a communication module for communication in the above-mentioned high-speed line connecting the base station device 1830 (wireless communication interface 1834) to the RRH 1820.

The RRH 1820 includes a connection interface 1823 and a wireless communication interface 1821.

The connection interface 1823 is an interface for connecting the RRH 1820 (wireless communication interface 1821) to the base station device 1830. The connection interface 1823 may also be a communication module for communication in the above-mentioned high-speed line.

The wireless communication interface 1821 transmits and receives wireless signals via the antenna 1810. The wireless communication interface 1821 may generally include, for example, an RF circuit 1822. The RF circuit 1822 may include, for example, a mixer, a filter, and an amplifier, and transmits and receives wireless signals via the antenna 1810. Although FIG. 18 illustrates an example in which one RF circuit 1822 is connected to one antenna 1810, the present disclosure is not limited to this illustration, but one RF circuit 1822 may be connected to multiple antennas 1810 at the same time.

As shown in FIG. 18, the wireless communication interface 1821 may include a plurality of RF circuits 1822. For example, the plurality of RF circuits 1822 may support multiple antenna elements. Although FIG. 18 illustrates an example in which the wireless communication interface 1821 includes a plurality of RF circuits 1822, the wireless communication interface 1821 may include a single RF circuit 1822.

### Example of User Device/Terminal Device

### First Example

FIG. 19 is a block diagram illustrating an example of a schematic configuration of a communication device 1900, such as smartphone, linker, etc., to which the technology of the present disclosure can be applied. The communication device 1900 includes a processor 1901, a memory 1902, a storage device 1903, an external connection interface 1904, a camera device 1906, a sensor 1907, a microphone 1908, an input device 1909, a display device 1910, a speaker 1911, a wireless communication interface 1912, one or more antenna switches 1915, one or more antennas 1916, a bus 1917, a battery 1918, and an auxiliary controller 1919. In an implementation manner, the communication device 1900 (or the processor 1901) herein may correspond to the foregoing transmit device or terminal-side electronic device.

The processor 1901 may be, for example, a CPU or a system on chip (SoC), and controls functions of an application layer and another layer of the smartphone 1900. The memory 1902 includes a RAM and a ROM, and stores data and programs executed by the processor 1901. The storage device 1903 may include a storage medium such as a semiconductor memory and a hard disk. The external connection interface 1904 is an interface for connecting external devices such as a memory vehicled and a universal serial bus (USB) device to the smartphone 1900.

The camera device 1906 includes an image sensor such as a charge-coupled device (CCD) and a complementary metal oxide semiconductor (CMOS), and generates a captured image. The sensor 1907 may include a set of sensors such as a measurement sensor, a gyroscope sensor, a geomagnetic sensor, and an acceleration sensor. The microphone 1908 converts a sound input to the smartphone 1900 into an audio signal. The input device 1909 includes, for example, a touch sensor, a keypad, a keyboard, a button, or a switch configured to detect a touch on the screen of the display device 1910, and receives an operation or information input from a user. The display device 1910 includes a screen such as a liquid crystal display (LCD) and an organic light emitting diode (OLED) display, and displays an output image of the smartphone 1900. The speaker 1911 converts an audio signal output from the smartphone 1900 into a sound.

The wireless communication interface 1912 supports any cellular communication scheme such as LTE and LTE-Advanced, and performs wireless communication. The wireless communication interface 1912 may generally include, for example, a BB processor 1913 and an RF circuit 1914. The BB processor 1913 may perform, for example, encoding/decoding, modulation/demodulation, and multiplexing/demultiplexing, and perform various types of signal processing for wireless communication. Meanwhile, the RF circuit 1914 may include, for example, a mixer, a filter, and an amplifier, and transmits and receives wireless signals via the antenna 1916. The wireless communication interface 1912 may be a chip module on which a BB processor 1913 and an RF circuit 1914 are integrated. As shown in FIG. 19, the wireless communication interface 1912 may include multiple BB processors 1913 and multiple RF circuits 1914. Although FIG. 19 illustrates an example in which the wireless communication interface 1912 includes a plurality of BB processors 1913 and a plurality of RF circuits 1914, the wireless communication interface 1912 may also include a single BB processor 1913 or a single RF circuit 1914.

In addition, in addition to the cellular communication scheme, the wireless communication interface 1912 may support other types of wireless communication scheme, such as a short-range wireless communication scheme, a near field communication scheme, and a wireless local area network (LAN) scheme. In this case, the wireless communication interface 1912 may include a BB processor 1913 and an RF circuit 1914 for each wireless communication scheme.

Each of the antenna switches 1915 switches a connection destination of the antenna 1916 between a plurality of circuits included in the wireless communication interface 1912 (for example, circuits for different wireless communication schemes).

Each of the antennas 1916 includes a single or multiple antenna elements, such as multiple antenna elements included in a MIMO antenna, and is used for the wireless communication interface 1912 to transmit and receive wireless signals. As shown in FIG. 19, the smartphone 1900 may include a plurality of antennas 1916. Although FIG. 19 illustrates an example in which the smart phone 1900 includes a plurality of antennas 1916, the smart phone 1900 may also include a single antenna 1916.

In addition, the smartphone 1900 may include an antenna 1916 for each wireless communication scheme. In this case, the antenna switch 1915 may be omitted from the configuration of the smartphone 1900.

The bus 1917 connects the processor 1901, the memory 1902, the storage device 1903, the external connection interface 1904, the camera device 1906, the sensor 1907, the microphone 1908, the input device 1909, the display device 1910, the speaker 1911, the wireless communication interface 1912, and the auxiliary controller 1919 to each other. The battery 1918 supplies power to each block of the smartphone 1900 shown in FIG. 19 via a feeder, and the feeder is partially shown as a dotted line in the figure. The auxiliary controller 1919 operates the minimum necessary functions of the smartphone 1900 in the sleep mode, for example.

### Second Example

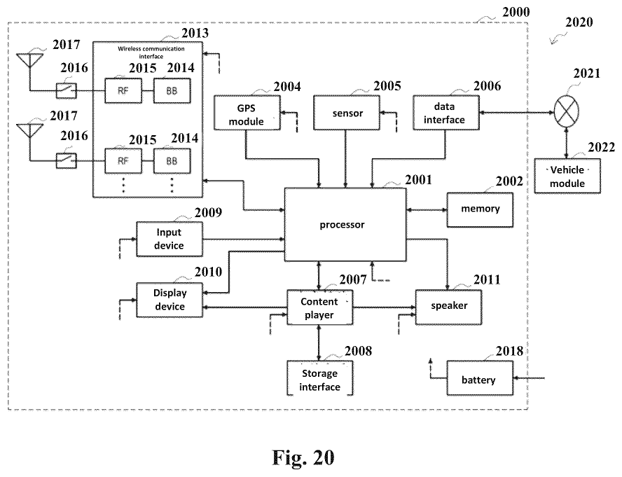

FIG. 20 is a block diagram illustrating an example of a schematic configuration of a vehicle navigation device 2000 to which the technology of the present disclosure can be applied. The vehicle navigation device 2000 includes a processor 2001, a memory 2002, a global position system (GPS) module 2004, a sensor 2005, a data interface 2006, a content player 2007, a storage medium interface 2008, an input device 2009, a display device 2010, a speaker 2011, and a wireless communication interface 2013, one or more antenna switches 2016, one or more antennas 2017, and a battery 2018. In an implementation manner, the vehicle navigation device 2000 (or the processor 2001) herein may correspond to the transmit device or terminal-side electronic device.

The processor 2001 may be, for example, a CPU or a SoC, and controls navigation functions and other functions of the vehicle navigation device 2000. The memory 2002 includes a RAM and a ROM, and stores data and programs executed by the processor 2001.

The GPS module 2004 uses a GPS signal received from a GPS satellite to measure the position (such as latitude, longitude, and altitude) of the vehicle navigation device 2000. The sensor 2005 may include a set of sensors such as a gyroscope sensor, a geomagnetic sensor, and an air pressure sensor. The data interface 2006 is connected to, for example, an in-vehicle network 2021 via a terminal not shown, and acquires data (such as vehicle speed data) generated by the vehicle.

The content player 2007 reproduces content stored in a storage medium such as a CD and a DVD, which is inserted into the storage medium interface 2008. The input device 2009 includes, for example, a touch sensor, a button, or a switch configured to detect a touch on the screen of the display device 2010, and receives an operation or information input from a user. The display device 2010 includes a screen such as an LCD or OLED display, and displays an image of a navigation function or reproduced content. The speaker 2011 outputs the sound of the navigation function or the reproduced content.

The wireless communication interface 2013 supports any cellular communication scheme such as LTE and LTE-Advanced, and performs wireless communication. The wireless communication interface 2013 may generally include, for example, a BB processor 2014 and an RF circuit 2015. The BB processor 2014 may perform, for example, encoding/decoding, modulation/demodulation, and multiplexing/demultiplexing, and perform various types of signal processing for wireless communication. Meanwhile, the RF circuit 2015 may include, for example, a mixer, a filter, and an amplifier, and transmit and receive wireless signals via the antenna 2017. The wireless communication interface 2013 may also be a chip module on which a BB processor 2014 and an RF circuit 2015 are integrated. As shown in FIG. 20, the wireless communication interface 2013 may include a plurality of BB processors 2014 and a plurality of RF circuits 2015. Although FIG. 20 illustrates an example in which the wireless communication interface 2013 includes a plurality of BB processors 2014 and a plurality of RF circuits 2015, the wireless communication interface 2013 may also include a single BB processor 2014 or a single RF circuit 2015.

In addition, in addition to the cellular communication scheme, the wireless communication interface 2013 may support other types of wireless communication scheme, such as a short-range wireless communication scheme, a near field communication scheme, and a wireless LAN scheme. In this case, the wireless communication interface 2013 may include a BB processor 2014 and an RF circuit 2015 for each wireless communication scheme.

Each of the antenna switches 2016 switches the connection destination of the antenna 2017 between a plurality of circuits included in the wireless communication interface 2013, such as circuits for different wireless communication schemes.

Each of the antennas 2017 includes a single or multiple antenna element, such as multiple antenna elements included in a MIMO antenna, and is used for the wireless communication interface 2013 to transmit and receive wireless signals. As shown in FIG. 20, the vehicle navigation device 2000 may include a plurality of antennas 2017. Although FIG. 20 illustrates an example in which the vehicle navigation device 2000 includes a plurality of antennas 2017, the vehicle navigation device 2000 may also include a single antenna 2017.

In addition, the vehicle navigation device 2000 may include an antenna 2017 for each wireless communication scheme. In this case, the antenna switch 2016 may be omitted from the configuration of the vehicle navigation device 2000.

The battery 2018 supplies power to each block of the vehicle navigation device 2000 shown in FIG. 20 via a feeder, and the feeder is partially shown as a dotted line in the figure. The battery 2018 accumulates power provided from the vehicle.

The technology of the present disclosure may also be implemented as a vehicle on-board system (or vehicle) 2020 including one or more of a vehicle navigation device 2000, an in-vehicle network 2021, and a vehicle module 2022. The vehicle module 2022 generates vehicle data such as vehicle speed, engine speed, and failure information, and outputs the generated data to the in-vehicle network 2021.

The exemplary embodiments of the present disclosure have been described with reference to the drawings, but the present disclosure is of course not limited to the above examples. Those skilled in the art may find various alternations and modifications within the scope of the appended claims, and it should be understood that they will naturally fall in the technical scope of the present disclosure.

It should be understood that the machine-readable instructions in the machine-readable storage medium or program products according to embodiments of the present disclosure can be configured to perform the operations corresponding to the above-described device and method embodiments. When referring to the above-mentioned device and method embodiments, the embodiments of machine-readable storage media or program products are clear to those skilled in the art, so their description will not be repeated. Such storage media may include, but are not limited to, floppy disks, optical disks, magneto-optical disks, memory cards, memory sticks, etc.

It should be noted that the series of processes and devices described above can be implemented as software and/or firmware.

In the case of implementation by software and/or firmware, corresponding programs constituting the corresponding software are stored in the storage medium of the related device, and the programs, when executed, can perform various functions. For example, a plurality of functions included in one unit in the above embodiment can be realized by separate devices. Alternatively, a plurality of functions included in one unit in the above embodiments may be respectively realized by separate devices. In addition, one of the above functions can be realized by multiple units, and such a configuration is also included in the technical scope of this disclosure.

In this specification, the steps described in the flowchart include not only the processes that are executed in time series in the stated order, but also the processes that are executed in parallel or solely instead of necessarily in time series. In addition, even in the step of processing in time series, needless to say, the order can be appropriately changed.

### Exemplary Embodiment Examples of the Present Disclosure

According to embodiments of the present disclosure, a variety of exemplary examples (EE) for implementing the concept of the present disclosure can be conceived, including but not limited to:

EE1. A transmit-side electronic device in a wireless communication system, the electronic device including a processing circuit configured to:
determine a group common beam for communication with a group of terminal devices in the wireless communication system, the group of terminal devices comprising one or more terminal devices; and
transmit information about the group common beam to at least one of the terminal devices by using the determined group common beam.

EE 2. The transmit-side electronic device of EE 1, wherein the processing circuit is further configured to:
group terminal devices in the wireless communication system based on acquired information about positions of the terminal devices.

EE 3. The transmit-side electronic device of EE 1, wherein the processing circuit is further configured to:
notify each terminal device in the wireless communication system of a group information of the terminal device through radio resource control (RRC) or medium access control (MAC) signaling.

EE 4. The transmit-side electronic device of EE 1, wherein the group information includes a wireless network temporary identification code of a device group to which the terminal device belongs.

EE 5. The transmit-side electronic device of EE 1, wherein the processing circuit is further configured to:
determine the group common beam by performing beam sweeping by a control-side device with respect to a key terminal device in the group of terminal devices.

EE 6. The transmit-side electronic device of EE 5, wherein the key terminal device is selected based on communication capabilities of the terminal devices.

EE 7. The transmit-side electronic device of EE 5, wherein the key terminal device is determined by polling among a plurality of terminal devices in the group of terminal devices.

EE 8. The transmit-side electronic device of EE 1, wherein the processing circuit is further configured to:
perform beam sweeping with respect to each terminal device in the group of terminal devices by using the group common beam, so as to determine a beam for each terminal device communicating with the transmit-side electronic device.

EE 9. The transmit-side electronic device of EE 1, wherein the processing circuit utilizes the group common beam to transmit relevant information about the group common beam to a corresponding group of terminal devices via a group common physical downlink control channel (PDCCH).

EE 10. The transmit-side electronic device of EE 1, wherein the processing circuit utilizes the group common beam to transmit relevant information about the group common beam to a corresponding terminal device via a group common medium access control-control element (MAC CE).

EE 11. The transmit-side electronic device of EE 1, wherein the processing circuit utilizes the group common beam to transmit relevant information about the group common beam to a specific terminal device in the group of terminal devices via a terminal device-dedicated physical downlink control channel (PDCCH), and the specific terminal device notifies other terminal devices in the terminal device group of the relevant information.

EE 12. A receive-side electronic device in a wireless communication system, comprising a processing circuit configured to:
acquire beam information about a group common beam from a transmit-side electronic device in a wireless communication system; and
determine a receive beam for communication with the transmit-side electronic device, based on the acquired beam information.

EE 13. The receive-side electronic device of EE 12, wherein the receive-side electronic device is a key device in a group of terminal devices, which is set based on communication capabilities of the terminal devices and/or determined by polling among a plurality of terminal devices in the group of terminal devices.

EE 14. The receive-side electronic device of EE 13, wherein the processing circuit is further configured to:
determine the group common beam by performing an initial beam sweeping with a control-side device; and
report information about the group common beam to the transmit-side electronic device.

EE 15. The receive-side electronic device of EE 13, wherein the processing circuit is further configured to notify other terminal devices in the group of terminal devices of relevant information about the group common beam.

EE 16. The receive-side electronic device of EE 12, wherein the processing circuit is further configured to:
receive and decode relevant information about the group common beam transmitted by the transmit-side device via the group common beam, so as to determine a receive beam corresponding to the group common beam from the transmit-side device.

EE 17. The receive-side electronic device of EE 16, wherein the relevant information about the group common beam is transmitted by the transmit-side device via the group common beam in any of the following ways:
Transmission via group common physical downlink control channel (PDCCH);
Transmission via a dedicated physical downlink shared channel (PDSCH) of each terminal device in the group of terminal devices; and
Transmission via group common physical downlink shared channel (PDSCH).

EE 18. A method for a transmit-side in a wireless communication system, the method comprising:
determining a group common beam for communication with a group of terminal devices in the wireless communication system, the group of terminal devices comprising one or more terminal devices; and
transmitting information about the group common beam to at least one of the terminal devices by using the determined group common beam.

EE 19. A method for a receive side in a wireless communication system, the method comprising:
acquiring beam information about a group common beam from a transmit-side electronic device in a wireless communication system; and
determining a receive beam for communication with the transmit-side electronic device, based on the acquired beam information.

EE 20. A device comprising
at least one processor; and
at least one storage device that stores instructions thereon that, when executed by the at least one processor, cause the at least one processor to execute the method of any one of EE 18 or 19.

EE 21. A storage medium storing instructions which, when executed by a processor, cause execution of the method of any one of EE 18 or 19.

EE 22. An apparatus comprising means for performing the method of any one of EE 18 or 19.

Although the present disclosure and its advantages have been described in detail, it should be understood that various changes, substitutions and alterations can be made hereto without departing from the spirit and scope of the present disclosure as defined by the appended claims. Furthermore, the terms “including”, “comprising”, or any other variation thereof, of the embodiments of the present disclosure are intended to encompass non-exclusive inclusion, such that a process, method, article, or device that includes a series of elements includes not only those elements, but also includes other elements not explicitly listed, or those inherent in the process, method, article, or equipment. Without more restrictions, the elements defined by the sentence “including a . . . ” do not exclude the existence of other identical elements in the process, method, article, or equipment including the elements.

Although some specific embodiments of the present disclosure have been described in detail, those skilled in the art should understand that the above-described embodiments are merely illustrative and do not limit the scope of the present disclosure. Those skilled in the art should understand that the above-described embodiments may be combined, modified, or replaced without departing from the scope and essence of the present disclosure. The scope of the present disclosure is defined by the appended claims.

1. A transmit-side electronic device in a wireless communication system, the electronic device including a processing circuit configured to:
determine a group common beam for communication with a group of terminal devices in the wireless communication system, the group of terminal devices comprising one or more terminal devices; and
transmit information about the group common beam to at least one of the terminal devices by using the determined group common beam.

2. The transmit-side electronic device of claim 1, wherein the processing circuit is further configured to:
group terminal devices in the wireless communication system based on acquired information about positions of the terminal devices.

3. The transmit-side electronic device of claim 1, wherein the processing circuit is further configured to:
notify each terminal device in the wireless communication system of a group information of the terminal device through radio resource control (RRC) or medium access control (MAC) signaling
and
wherein the group information includes a wireless network temporary identification code of a device group to which the terminal device belongs.

4. (canceled)

5. The transmit-side electronic device of claim 1, wherein the processing circuit is further configured to:
determine the group common beam by performing beam sweeping by a control-side device with respect to a key terminal device in the group of terminal devices, and
wherein
the key terminal device is selected based on communication capabilities of the terminal devices, and/or
wherein the key terminal device is determined by polling among a plurality of terminal devices in the group of terminal devices.

6.-7. (canceled)

8. The transmit-side electronic device of claim 1, wherein the processing circuit is further configured to:
perform beam sweeping with respect to each terminal device in the group of terminal devices by using the group common beam, so as to determine a beam for each terminal device communicating with the transmit-side electronic device.

9. The transmit-side electronic device of claim 1, wherein the processing circuit utilizes the group common beam to transmit relevant information about the group common beam to a corresponding group of terminal devices via a group common physical downlink control channel (PDCCH), and/or
wherein the processing circuit utilizes the group common beam to transmit relevant information about the group common beam to a corresponding terminal device via a group common medium access control-control element (MAC CE), and/or
wherein the processing circuit utilizes the group common beam to transmit relevant information about the group common beam to a specific terminal device in the group of terminal devices via a terminal device-dedicated physical downlink control channel (PDCCH), and the specific terminal device notifies other terminal devices in the terminal device group of the relevant information.

10.-11. (canceled)

12. A receive-side electronic device in a wireless communication system, comprising a processing circuit configured to:
acquire beam information about a group common beam from a transmit-side electronic device in a wireless communication system; and
determine a receive beam for communication with the transmit-side electronic device, based on the acquired beam information.

13. The receive-side electronic device of claim 12, wherein the receive-side electronic device is a key device in a group of terminal devices, which is set based on communication capabilities of the terminal devices and/or determined by polling among a plurality of terminal devices in the group of terminal devices.

14. The receive-side electronic device of claim 12, wherein the processing circuit is further configured to:
determine the group common beam by performing an initial beam sweeping with a control-side device; and
report information about the group common beam to the transmit-side electronic device.

15. (canceled)

16. The receive-side electronic device of claim 12, wherein the processing circuit is further configured to:
receive and decode relevant information about the group common beam transmitted by the transmit-side device via the group common beam, so as to determine a receive beam corresponding to the group common beam from the transmit-side device.

17. (canceled)

18. A method on a transmit-side in a wireless communication system, the method comprising:
determining a group common beam for communication with a group of terminal devices in the wireless communication system, the group of terminal devices comprising one or more terminal devices; and
transmitting information about the group common beam to at least one of the terminal devices by using the determined group common beam.

19. (canceled)

20. The method of claim 18, further comprising:
notifying each terminal device in the wireless communication system of a group information of the terminal device through radio resource control (RRC) or medium access control (MAC) signaling,
wherein the group information includes a wireless network temporary identification code of a device group to which the terminal device belongs.

21. (canceled)

22. The method of claim 18, further comprising:
determining the group common beam by performing beam sweeping by a control-side device with respect to a key terminal device in the group of terminal devices,
wherein the key terminal device is selected based on communication capabilities of the terminal devices, and/or wherein the key terminal device is determined by polling among a plurality of terminal devices in the group of terminal devices.

23.-25. (canceled)

26. The method of claim 18, wherein the group common beam is utilized to transmit relevant information about the group common beam to a corresponding group of terminal devices via a group common physical downlink control channel (PDCCH), and/or
wherein the group common beam is utilized to transmit relevant information about the group common beam to a corresponding terminal device via a group common medium access control-control element (MAC CE), and/or
wherein the group common beam is utilized to transmit relevant information about the group common beam to a specific terminal device in the group of terminal devices via a terminal device-dedicated physical downlink control channel (PDCCH), and the specific terminal device notifies other terminal devices in the terminal device group of the relevant information.

27.-34. (canceled)

35. A device, comprising
at least one processor; and
at least one storage device that stores instructions thereon which, when executed by the at least one processor, cause the at least one processor to execute the method of claim 18.

36. A non-transitory computer readable storage medium storing instructions which, when executed by a processor, cause execution of the method of claim 18.

37.-38. (canceled)

39. A device, comprising at least one processor; and at least one storage device that stores instructions thereon which, when executed by the at least one processor, cause the at least one processor to execute the method of claim 20.

40. A non-transitory computer readable storage medium storing instructions which, when executed by a processor, cause execution of the method of claim 20.

41. A device, comprising at least one processor; and at least one storage device that stores instructions thereon which, when executed by the at least one processor, cause the at least one processor to execute the method of claim 26.

42. A non-transitory computer readable storage medium storing instructions which, when executed by a processor, cause execution of the method of claim 26.
